(19) United States
(12) Patent Application Publication
(10) Pub. No.: US 2012/0023234 A1
(43) Pub. Date: Jan. 26, 2012

(54) Method and Apparatus for Establishing a Connection

(75) Inventor: Brian Alexander Martin, Farnham (GB)

(73) Assignee: NOKIA CORPORATION, Espoo (FI)

(21) Appl. No.: 12/841,134

(22) Filed: Jul. 21, 2010

(51) Int. Cl. G06F 15/173; G06F 15/16

(52) U.S. Cl. 709/226; 709/227

(57) ABSTRACT

In accordance with an example embodiment of the present invention, a user equipment stores data to be transmitted, determines that the data is to be transmitted, and transmits a new connection establishment message toward a network node or access point, wherein the new connection establishment message comprises an indication relating to releasing resources allocated to the new connection. The indication may relate to one-off connection type or specify a quantity relating to the new connection, for example.

### TECHNICAL FIELD

The present application relates generally to connectivity in the context of distributed or cellular communications.

### BACKGROUND

Distributed, or peer-to-peer, and cellular communications can take place in the contexts of person-to-person, person-to-machine, machine-to-person, or machine-to-machine communication.

Person-to-person communication comprises inter-person telephone communications, for example. Cellular networks originally designed to support person-to-person communications have been used also for machine-centric communication. This may entail a person accessing a network such as the Internet using a personal communications device, or a home security appliance reporting data to a central repository using a cellular network as communication medium, for example. In general, machine-centric communications may be any communication where at least one endpoint is not a person but a machine. In detail, machine-centric communication comprises communication between two automated machines.

The Third Generation Partnership Project, 3GPP, has studied requirements relating to machine-centric communications. Machine-centric communications have characteristics that differ from person-centric communications, for example where both endpoints are static, automated machines mobility procedures may be rarely needed. In some cases, the type of machine affects the types of communication required, for example a closed-circuit camera feed may only require a constant quality of service selected as suitable but not excessive for conveying a video feed from the unit. In such a case, procedures for dynamically changing the quality of service may be rarely, if ever, needed.

### SUMMARY

Various aspects of examples of the invention are set out in the claims.

According to a first aspect of the present invention, there is provided an apparatus, comprising a memory configured to store data to be transmitted over a connection, logic circuitry configured to determine a requirement to establish a new connection, a transmitter configured to transmit a new connection establishment message, wherein the new connection establishment message comprises an indication relating to releasing resources allocated to the new connection.

According to a second aspect of the present invention, there is provided a method, comprising storing data to be transmitted over a connection, determining a requirement to establish a new connection, and transmitting a new connection establishment message, wherein the new connection establishment message comprises an indication relating to releasing resources allocated to the new connection.

According to a third aspect of the present invention, there is provided an apparatus, comprising at least one processor, at least one memory including computer program code, the at least one memory and the computer program code configured to, with the at least one processor, cause the apparatus to perform at least the following: receive a new connection establishment message, wherein the new connection establishment message comprises an indication relating to releasing resources allocated to the new connection, participate in establishing the requested new connection, and release the new connection in accordance with the indication relating to releasing resources allocated to the new connection.

According to some embodiments, the indication may comprise an indication of a type of new connection or an indication of a quantity relating to the new connection. Examples of types of new connection include a one-off connection and a machine-to-machine connection. Examples of quantities relating to the new connection include an amount of information to be conveyed over the new connection and a requested timeout period for the new connection.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an arrangement where some embodiments of the invention may be practiced;

FIG. 2 illustrates an example apparatus capable of supporting embodiments of the present invention;

FIG. 3 is a flowchart of an example process according to some embodiments of the invention; and

FIG. 4 is a flowchart of an example process according to some embodiments of the invention.

### DETAILED DESCRIPTION OF THE DRAWINGS

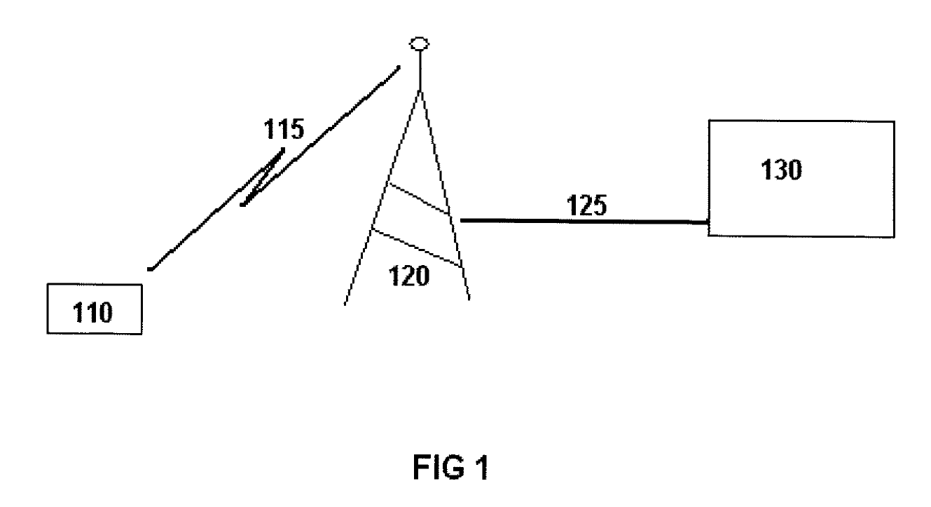

An example embodiment of the present invention and its potential advantages are understood by referring to FIGS. 1 through 4 of the drawings.

FIG. 1 illustrates an arrangement where some embodiments of the invention may be practiced. FIG. 1 illustrates apparatus 110, which may be for example a cellular telephone or an automated machine. Examples of automated machines include closed-circuit television monitoring machines and automated meters such as electricity or gas meters. Apparatus 110 may be configured to autonomously, without user intervention, transmit information stored in an internal or external memory of apparatus 110. Apparatus 110 may be configured to, responsive to determining that information stored in a memory of apparatus 110 needs to be transmitted, cause a connection 115 to be established. Apparatus 110 may be configured to transmit information periodically, responsive to a determination that a predetermined amount of information has accumulated in a memory of apparatus 110 or responsive to a trigger event. Examples of trigger events include detection of motion in a motion sensor, detection of a predetermined temperature in a temperature sensor, determination that a temperature has changed by a predetermined number of degrees in a predetermined amount of time, or a determination that a usage rate of electricity or gas changes. In some embodiments, a trigger event is reception in apparatus 110 of a request to provide data.

Connection 115 allows apparatus 110 to transmit information to base station 120. Connection 115 may also allow apparatus 110 to receive information from base station 120. Connection 115 may be a connection according to wideband code division multiple access, WCDMA, global system for mobile communications, GSM, long term evolution, LTE, or other wireless technology. In some embodiments connection 115 may be a wire-line connection instead of a wireless connection. Connection 115 may comprise an uplink connection for conveying information from apparatus 110 to base station 120. Connection 115 may comprise a downlink for conveying information from base station 120 to apparatus 110. Base station 120 comprises equipment configured to support connection 115, for example in embodiments where connection 115 is in accordance with WCDMA technology, base station 120 comprises at least equipment arranged to support WCDMA connections.

Connection 115 may comprise resources reserved for the connection. Radio resources of a wireless connection 115 may comprise frequency, time, code or space resources, for example. Resources reserved for connection 115 may comprise a certain time-slice on a certain spreading code, which is used to spread a signal over a certain frequency band. In embodiments where connection 115 is wire-line, resources of the connection may comprise timeslots allocated to connection 115. Connection 115 may comprise encryption, authentication and charging aspects handled by the system in which base station 120 is comprised. An active connection 115 may comprise data transmission, or at least periodic keep-alive packets arranged to prevent timeout timers from dismantling connection 115. Transmitting, receiving and processing keep-alive packets consume a certain amount of energy in apparatus 110 and base station 120, wherefore connection 115, when active, consumes energy even when no active data transmission is ongoing.

Backbone connection 125 conveys information between base station 120 and core network 130. Core network 130 may be connected to more than one radio-access network, each radio-access network comprising a plurality of base stations. Core network 130 may be shared between network operators. Backbone connection 125 may be wire-line or wireless, an example a wireless backbone connection 125 is a microwave link interconnecting base station 120 and core network 130. Core network 130 may comprise a gateway node, not illustrated, operatively connected to external networks. In an example embodiment, apparatus 110 may be configured to transmit information via base station 120 and core network 130 to a proprietary network or a corporation that owns apparatus 110. An example of such an arrangement is one where apparatus 110 is an electric meter configured to transmit information to corporate network of an electric utility corporation.

In cases where apparatus 110 transmits information infrequently, it may be advantageous to release connection 115 when no transmission is ongoing in order to release the resources allocated to connection 115 for active communications by other apparatuses, or alternatively or additionally to conserve energy spent in keeping connection 115 active. Whether it is advantageous to release connection 115 in-between transmissions may depend on, for example, the ratio of transmission gaps to lengths of transmissions wherein a transmission gap is a length of time from the end of a transmission to the start of a next transmission.

When connection 115 is to be released after a transmission, apparatus 110 may transmit to base station 120, over connection 115, a connection teardown signal. Responsive to receiving a connection teardown signal, base station 120 may be configured to autonomously or in co-operation with core network 130 cause connection 115 to be released and resources allocated to connection 115 to be considered available for other connections. Alternatively apparatus 110 may, responsive to having completed a transmission of information, simply wait. Responsive to determining that connection 115 has been inactive for a predetermined period of time, base station 120 and/or core network 130 may initiate releasing connection 115. The predetermined period may be called a timeout period, which may be monitored by base station 120 and/or core network 130. Connection 115 may be considered to be inactive if there is no traffic in either the uplink or the downlink direction during the timeout period, aside from keepalive packets. Transmitting the teardown signal accomplishes release of connection 115 faster than the timeout period, however transmitting the teardown signal consumes energy and depending on the technology utilized in connection 115, may cause interference to other connections sharing at least partly the resources allocated to connection 115.

In accordance with certain embodiments of the present invention, when apparatus 110 determines that information stored in a memory of apparatus 110 needs to be transmitted, apparatus 110 requests a connection 115 to be established between apparatus 110 and base station 120 with an indication relating to releasing resources allocated to connection 115. The indication may be transmitted in an initial request for connection 115, or as part of a signaling exchange between apparatus 110 and base station 120 to establish connection 115. For example, the indication may be comprised in a radio resource control connection request message, or a radio resource control connection setup complete message sent from apparatus 110 to base station 120. In general, signaling between apparatus 110 and base station 120 aimed at establishing connection 115 comprises new connection establishment messages of various types.

In some embodiments, the indication indicates a type of connection 115, for example that connection 115 is not conversational, or that connection 115 is a “one-off” connection comprising primarily a block of information transmitted from apparatus 110. The indication may also indicate an establishment cause conveying the purpose of connection 115, which can be taken into account when determining when to release connection 115 without an explicit teardown signal from apparatus 110. An establishment cause can differentiate a machine-centric connection 115 from person-to-person connections that base station 120 and core network 130 may also serve. The operator or operators of base station 120 and core network 130 may also be interested to compile statistics on how much machine-centric communication their network carries. An indication as to connection type can facilitate compilation of such statistics.

In some embodiments, the indication comprises at least one quantity relating to connection 115. For example, an indicated quantity may be an amount of data to be transmitted over connection 115. In embodiments where apparatus 110 requests connection 115 responsive to accumulating a certain amount of data, apparatus 110 will be in possession of the quantity of data to be transmitted over connection 115 prior to connection 115 being established. Responsive to receiving an indication of data quantity, base station 120 and/or core network 130 may be configured to cause connection 115 to be torn down responsive to receiving the indicated quantity of data without waiting for a timeout and/or without waiting for a teardown signal from apparatus 110. Apparatus 110 may be in possession of knowledge relating to the quantity of data to be transmitted over connection 115 also by other ways, for example apparatus 110 may be configured to stream or send a known amount of data at set intervals or responsive to a trigger. An example of this would be an embodiment where apparatus 110 is a surveillance camera configured to transmit one frame of image data responsive to a motion-sensor detecting movement or at set time intervals.

In some embodiments, the quantity relating to connection 115 is a desired timeout period for connection 115. When apparatus 110 knows that connection 115 is established to transmit a block of information to base station 120, apparatus 110 will also know that subsequent to the transmission of the block of information, connection 115 will be redundant. The timeout period may be set to a default setting in the cellular network where base station 120 is comprised, and the default may be selected for interactive communications, for example. In interactive communications, an appropriate timeout period may be long compared to an appropriate timeout period in machine-to-machine communications. When a user is browsing the Internet, for example, using a mobile device, he will occasionally click on links to request further web pages to be downloaded into his device. The time in-between clicks may be in the order of minutes and it would ne inappropriate to tear down the connection between his mobile device and the network during that time. In contrast, subsequent to the block of information being successfully sent connection 115 may be torn down more or less immediately. Therefore apparatus 110 may insert in a connection establishment message a requested timeout period, for example one selected from one of the following ranges, for example: one to ten seconds, 160 to 320 milliseconds, 320 to 640 milliseconds and 640 to 1280 milliseconds.

Responsive to receiving an indication relating to release of resources allocated to connection 115, the network base station 120 is comprised in may take appropriate actions, for example applying a requested timeout value, or allocating a limited amount of resources to a connection indicated as being meant to convey only a relatively small amount of information. The network may also choose to allocate resources in a lower-capacity technology to a one-off or low-data connection. For example, the network may choose to attach apparatus 110 to base station 120 using GSM technology instead of WCDMA or LTE technology. The network may also compile statistics on one-off connections, or overall on connections providing an indication relating to release of resources in a connection establishment message.

In some embodiments, responsive to receiving an indication that a connection is one-off, a network node such as, for example, base station 120 or a node in the core network 130 may be configured to apply a shorter timeout period to the connection. In other embodiments, a network node such as, for example, base station 120 or a node in the core network 130 may be configured to apply a shorter timeout period to the connection responsive to receiving any indication relating to release of resources allocated to the connection.

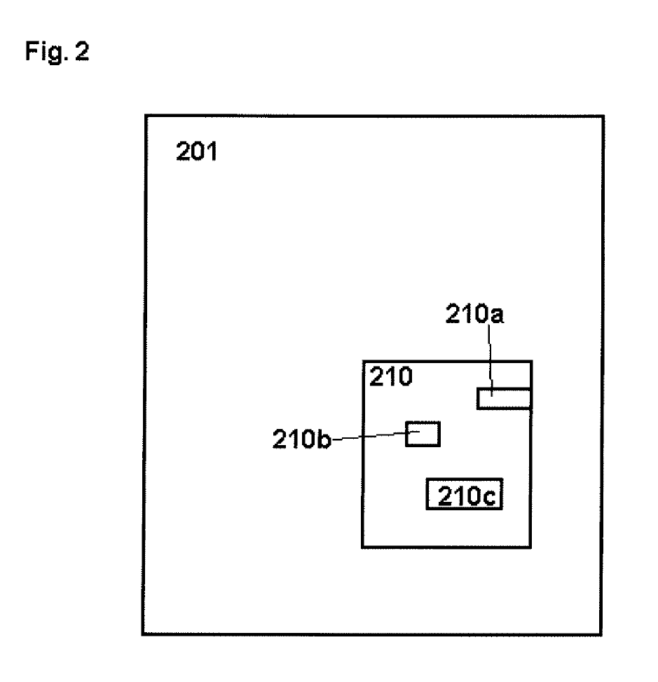

FIG. 2 illustrates an example apparatus 201 capable of supporting embodiments of the present invention. The apparatus may correspond to apparatus 110, base station 120 or a node in core network 130 of FIG. 1, for example. The apparatus is a physically tangible object, for example a mobile telephone, personal digital assistant, data dongle or a similar device. The apparatus may comprise a control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example sensor information accumulated in apparatus 201. The memory may be solid-state memory, dynamic random access memory, DRAM, magnetic, holographic or other kind of memory. The apparatus may comprise logic circuitry 210c configured to access the memory 210b and control the transmitter and/or a receiver 210a. The logic circuitry 210c may be implemented as software, hardware or a combination of software and hardware. The logic circuitry may comprise a processing core. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transmitter and/or a receiver 210a. The logic circuitry 210c may be control circuitry. The transmitter and/or a receiver 210a, memory 210b and/or logic circuitry 210c may comprise hardware and/or software elements comprised in the control apparatus 210. Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna.

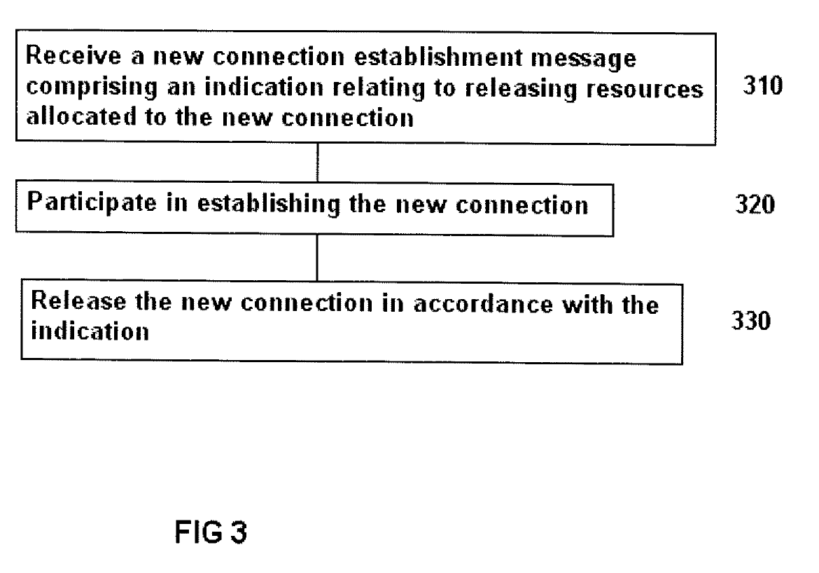

FIG. 3 is a flowchart of an example process according to some embodiments of the invention. In phase 310 a new connection establishment message is received by a base station or an access point. The new connection establishment message comprises an indication relating to releasing resources allocated to the new connection, as described above in connection with FIG. 1. In phase 320, the base station or access point participates in establishing the new connection that the new connection establishment message relates to. Phase 320 may commence before, during or after phase 310. In phase 320, the base station may take the indication into account when allocating resources to the new connection, for example the base station may decide to keep one-off type connections in a certain radio-access technology or assign resources to connections established with the indicator from a block of radio resources reserved for connections of the type. Another example of a way in which the base station, or other network node, may take the indication into account when allocating resources is that only a set bandwidth is allocated to the new connection and algorithms used in other traffic to increase a bandwidth of a data connection in use aren't used to modify the bandwidth of the new connection while it is in use. A yet further example is that a quality of service that is lower than a normal, or default, quality of service allocated to a new connection is allocated to the new connection established with the indicator. In phase 330, the new connection is released in accordance with the received indication.

As discussed in connection with FIG. 1, the indication may specify that the new connection is a one-off connection, the indication may specify a requested timeout period, or the indication may specify an amount of information to be conveyed over the new connection, for example. Releasing the new connection in accordance with the indication may comprise modifying the behaviour of the base station or access point responsive to the indication. In detail, where the indication specifies that the new connection is a one-off connection, the base station or access point, or other network node, may be configured to cause the new connection the be released substantially responsive to determining the new connection has been dormant for a timeout period that is shorter than a default timeout period. In embodiments where the indication specifies an amount of information to be conveyed over the new connection, the base station or access point, or other network node, may be configured to cause the new connection the be released substantially responsive to determining that the specified amount of information has been received over the new connection. In embodiments where the indication specifies a requested timeout period for the new connection, the base station or access point, or other network node, may be configured to cause the new connection the be released substantially responsive to determining that the new connection has been dormant for the requested timeout period.

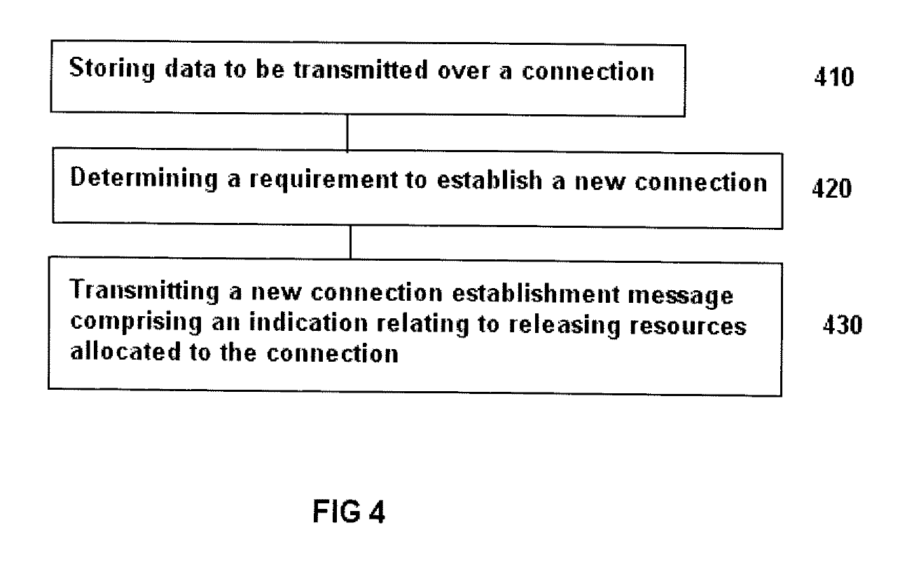

FIG. 4 is a flowchart of an example process according to some embodiments of the invention. In phase 410, an apparatus may be configured to store information in a memory. The data, or information, may be obtained for example from a sensor functionally connected to the apparatus. For example, in embodiments where the apparatus is a flow sensor, the stored data may be flow data obtained by the apparatus by observing a flow, such as a gas or water flow. The amount of data stored in phase 410 may depend on the embodiment. In embodiments where the apparatus is to transmit data only once per month, for example, the apparatus may be furnished with memory capable of storing data accumulated over a month. In embodiments where the apparatus is configured to transmit data responsive to a trigger event, memory requirements may be less strict, for example if the apparatus is configured to only begin collecting data responsive to the trigger event. In some embodiments, the apparatus is configured to accumulate data for periodic, for example monthly or weekly, transmission but is still configured to transmit accumulated data responsive to a trigger event.

In phase 420, the apparatus makes a determination that a new connection is required to be established. This determination may comprise, for example, a trigger event or a determination that a condition defined in the apparatus is fulfilled. For example, a condition may comprise that the present day is a certain day of a month, for example the first calendar day of a month, or that a certain number of hours, days, weeks, or other time units has elapsed from a previous transmission. A condition may also comprise that a certain proportion, for example a percentage, of a memory of the apparatus is filled with accumulated data. Other kinds of possible trigger events are described above. Phase 420 may occur before, after or during phase 410.

In phase 430, the apparatus may be configured to transmit a new connection establishment message, for example a radio resource control connection request or connection setup complete message. The new connection establishment message comprises an indication relating to releasing resources allocated to the connection. As discussed above in connection with FIG. 1, the indication may comprise an indication relating to a type of the new connection or the indication may comprise an indication of a quantity relating to the new connection, for example.

Without in any way limiting the scope, interpretation, or application of the claims appearing below, a technical effect of one or more of the example embodiments disclosed herein is that redundant machine-to-machine connections are torn down effectively without explicit signaling. Another technical effect of one or more of the example embodiments disclosed herein is that the network may determine how to allocate radio resources more effectively, such as allocation of channel bandwidth to a device or load balancing machine-to-machine communication across network nodes. Another technical effect of one or more of the example embodiments disclosed herein is that operators will be enabled to improve their statistics to include statistics concerning connections established for machine-to-machine or one-off purposes.

Embodiments of the present invention may be implemented in software, hardware, application logic or a combination of software, hardware and application logic. The software, application logic and/or hardware may reside in a mobile or static user equipment or network node, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a memory configured to store data to be transmitted over a connection;
logic circuitry configured to determine a requirement to establish a new connection; and
a transmitter configured to transmit a new connection establishment message, wherein the new connection establishment message comprises an indication relating to releasing resources allocated to the new connection.

2. An apparatus according to claim 1, wherein the indication indicates a type of the new connection.

3. An apparatus according to claim 2, wherein the indication indicates that the new connection is a one-off connection.

4. An apparatus according to claim 2, wherein the indication indicates an establishment cause of the new connection.

5. An apparatus according to claim 1, wherein the indication indicates a quantity relating to the new connection.

6. An apparatus according to claim 1, wherein the indication indicates a quantity of data to be transmitted over the new connection.

7. An apparatus according to claim 5, wherein the indication indicates a requested timeout value for the new connection.

8. An apparatus according to claim 7, wherein the requested timeout value is comprised in one of the following ranges: one to ten seconds, 160 to 320 milliseconds, 320 to 640 milliseconds and 640 to 1280 milliseconds.

9. An apparatus according to claim 1, wherein the new connection establishment message is either a radio resource control connection request message or a radio resource control connection setup complete message.

10. A user equipment comprising an apparatus according to claim 1 and at least one antenna.

11. A method, comprising:
storing data to be transmitted over a connection;
determining a requirement to establish a new connection; and
transmitting a new connection establishment message, wherein the new connection establishment message comprises an indication relating to releasing resources allocated to the new connection.

12. A method according to claim 11, wherein the new connection establishment message is either a radio resource control connection request message or a radio resource control connection setup complete message.

13. A method according to claim 11, wherein the indication indicates a one-off connection as a type of the new connection.

14. A method according to claim 11, wherein the indication indicates at least one of: a quantity of data to be transmitted over the new connection and a requested timeout value for the new connection.

15. An apparatus, comprising:
at least one processor; and
at least one memory including computer program code
the at least one memory and the computer program code configured to, with the at least one processor, cause the apparatus to perform at least the following:
receive a new connection establishment message, wherein the new connection establishment message comprises an indication relating to releasing resources allocated to the new connection;
participate in establishing the requested new connection; and
release the new connection in accordance with the indication relating to releasing resources allocated to the new connection.

16. An apparatus according to claim 15, wherein the indication relating to releasing resources allocated to the new connection comprises an indication that the new connection is a one-off connection, and wherein the releasing of the new connection in accordance with the indication comprises releasing the new connection responsive to a timeout period that is shorter than a default timeout period.

17. An apparatus according to claim 15, wherein the indication relating to releasing resources allocated to the new connection comprises a requested timeout period, and wherein the releasing of the new connection in accordance with the indication comprises releasing the new connection responsive to the requested timeout period.

18. A method, comprising:
receiving a new connection establishment message, wherein the new connection establishment message comprises an indication relating to releasing resources allocated to the new connection
participating in establishing the requested new connection; and
releasing the new connection in accordance with the indication relating to releasing resources allocated to the new connection.

19. A method according to claim 18, wherein the indication relating to releasing resources allocated to the new connection comprises an indication that the new connection is a one-off connection, and wherein the releasing of the new connection in accordance with the indication comprises releasing the new connection responsive to a timeout period that is shorter than a default timeout period.

20. A method according to claim 18, wherein establishing the new connection in accordance with the indication comprises determination of a suitable resource allocation based on the indicator.

21. A method according to claim 18, wherein the indication relating to releasing resources allocated to the new connection comprises a requested timeout period, and wherein the releasing of the new connection in accordance with the indication comprises releasing the new connection responsive to the requested timeout period.

22. A computer program product comprising a computer-readable medium bearing computer program code embodied therein for use with a computer, the computer program code comprising:
code for storing data to be transmitted over a connection;
code for determining a requirement to establish a new connection; and
code for transmitting a new connection establishment message, wherein the new connection establishment message comprises an indication relating to releasing resources allocated to the new connection.

23. A computer program product comprising a computer-readable medium bearing computer program code embodied therein for use with a computer, the computer program code comprising:
code for receiving a new connection establishment message, wherein the new connection establishment message comprises an indication relating to releasing resources allocated to the new connection
code for participating in establishing the requested new connection; and
code for releasing the new connection in accordance with the indication relating to releasing resources allocated to the new connection.
